(19) United States
(12) Patent Application Publication
(10) Pub. No.: US 2004/0019878 A1
(43) Pub. Date: Jan. 29, 2004

(54) Software tool to detect and restore damaged or lost software components

(76) Inventors: Sreekrishna Kotnur, Bangalore (IN); Sasank Kotnur, Bangalore (IN)

Correspondence Address: Welsh & Katz, Ltd., 22nd Floor, 120 South Riverside Plaza, Chicago, IL, 60606, US

(21) Appl. No.: 10/200,965

(22) Filed: Jul. 23, 2002

(51) Int. Cl. G06F 9/44; H02H 3/05; G06F 12/00

(52) U.S. Cl. 717/120; 714/38; 707/204

(57) ABSTRACT

A method of maintaining software components is provided. Software components may be maintained by configuring a component scanner, detecting damage, and restoring the component. The component scanner may be configured by selecting at least one software component, extracting predetermined details of the selected software component, storing the extracted predetermined details, and creating a backup repository for the selected component. Damage may be detected by determining the software components for detection by parsing the stored predetermined details, extracting the stored predetermined details, detecting discrepancies between the details of the selected software component and the extracted, stored predetermined details, and storing the results of the step of detecting discrepancies in a scan log. A software component may be restored by determining from the scan log a component to be recovered and restoring the software component to the state at which the predetermined details were extracted.

A computer environment configured to maintain software components is also provided. The computer environment may include a component scanner, configured to extract predetermined details from a selected software component, an information store, responsive to the component scanner and configured to store the predetermined details, a backup repository responsive to the component scanner and configured to store a copy of the selected component; and a scan log, responsive to the component scanner, and configured to store detected discrepancies. The component scanner may be further configured to detect damage to the selected software component by comparing the selected software component with the extracted predetermined details.

### FIELD OF INVENTION

The present invention relates generally to the computer programming methods, and in particular to component oriented programming methods.

### BACKGROUND OF THE INVENTION

Building better software in less time the goal of many software firms. In the last couple of decades significant advances have been achieved to address this. This has led to new and easier programming languages, better database systems and significant improvements in object oriented techniques. One such very significant improvement is the advent of component based development/programming techniques (also referred to as object-oriented programming).

Component based programming or development involves writing or developing relatively small components, each configured to perform a specific task or function. The integrated components may then form a larger component or software application capable of the tasks or functions of its constituent components.

Component based development has led a true implementation of one of the object oriented techniques, namely, reusability. Building software from components generally involves creating a software application in whole or in part from existing components. The components may be used again and again in the development of new software applications. Building components may be achieved by using smart tools as well as by traditional programming.

Most of the languages today, in one way or another support component based programming. It is envisioned that in the years to come, component based programming will be the norm by which software applications will be developed. Components are being developed and marketed by numerous software vendors. This has given the end user a wide range of components and vendors to choose from.

One drawback associated with object oriented programming is the lack of the ability to automatically detect and repair lost or damaged components deployed within an object request broker (ORB). This drawback is exacerbated by the wide range of vendors and components available for use.

What is needed is a computer maintenance tool that can detect damaged components and repair damaged components with minimal involvement from a human computer user.

### SUMMARY OF THE INVENTION

A method of maintaining software components is provided. Software components may be maintained by configuring a component scanner, detecting damage, and restoring the component. The component scanner may be configured by selecting at least one software component, extracting predetermined details of the selected software component, storing the extracted predetermined details, and creating a backup repository for the selected component. Damage may be detected by determining the software components for detection by parsing the stored predetermined details, extracting the stored predetermined details, detecting discrepancies between the details of the selected software component and the extracted, stored predetermined details, and storing the results of the step of detecting discrepancies in a scan log. The predetermined details may comprise a path corresponding to the selected component and a list of files corresponding to the selected component, a copy of the selected component, repositories, registries, and services corresponding to the selected component, a file footprint, method details or combinations of the above.

A software application may provide predetermined details to the component scanner. The component scanner may store the details by generating a detail key.

Detecting discrepancies may involve comparing the previously stored details with the current method details of a selected software components Detecting discrepancies may also include reading the path of the component, determining the list of files of the software component to scan, reading and preparing the properties of the files in the list; and comparing the properties of the files with the predetermined component details.

A software component may be restored by determining from the scan log a component to be recovered and restoring the software component to the state at which the predetermined details were extracted.

A computer environment configured to maintain software components is also provided. The computer environment may include a component scanner, configured to extract predetermined details from a selected software component, an information store, responsive to the component scanner and configured to store the predetermined details, a backup repository responsive to the component scanner and configured to store a copy of the selected component; and a scan log, responsive to the component scanner, and configured to store detected discrepancies. The component scanner may be further configured to detect damage to the selected software component by comparing the selected software component with the extracted predetermined details.

The computer environment may comprise a plurality of interconnected computer systems; wherein the component scanner, the information store, the backup repository, and the scan log reside on distinct computer systems. In the alternative, the computer environment of claim may comprising a single computer system; wherein the component scanner, the information store, the backup repository, and the scan log reside on the same computer system, or a combination of the above.

### BRIEF DESCRIPTION OF THE DRAWINGS

FIG. 1 depicts a first embodiment of the invention.

FIG. 2 depicts a second embodiment of the invention.

FIG. 3 depicts a third embodiment of the invention.

FIG. 4 is a flow chart depicting the configuring a component with a software component scanner.

FIG. 5 is the flow chart depicting the detection of changes to a component.

FIG. 6 is the flow chart depicting the recovery of the modified component.

FIG. 7 depicts a possible report generated by a reporting tool using the output generated by a component scanner.

### DETAILED DESCRIPTION OF THE PREFERRED EMBODIMENT

Several examples of the present invention are described in more detail with reference to the drawings. The present invention is not necessarily limited to these examples.

For example, the preferred embodiment of the present invention uses the JAVA programming language and environment. Implementation of the present invention, however, is not limited to JAVA only. The present invention may be applied to other programming languages by persons having ordinary skill in the art of computer programming.

In this description, the components calling on the methods of another component are herein after referred to as ‘subscriber components’, and the components providing such methods or services are herein after referred to as ‘publisher components’.

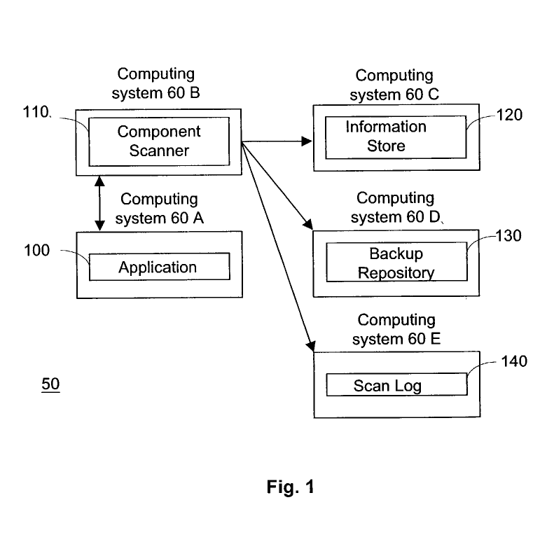

FIG. 1 illustrates a first example of a heterogeneous network computing environment 50 configured with a Component Scanner 110. The network computing environment 50 illustrated in FIG. 1 comprises the Component Scanner 110 residing on Computing System 60B, an Information Store 120 residing on Computing System 60C, a Backup Repository 130 residing on Computing System 60D, and a Scan Log 140 residing on Computing System 60E. One or more Applications 100 may also be installed on Computing System 60A. The Application 100 typically includes constituent software components. The Application 100 and/or its software components may make calls on additional software components. In the example illustrated in FIG. 1, the Component Scanner 110, the Information Store 120, the Backup Repository 130 and the Scan Log 140 are loosely coupled. The elements may reside independently of each other on the Computing Environment 50.

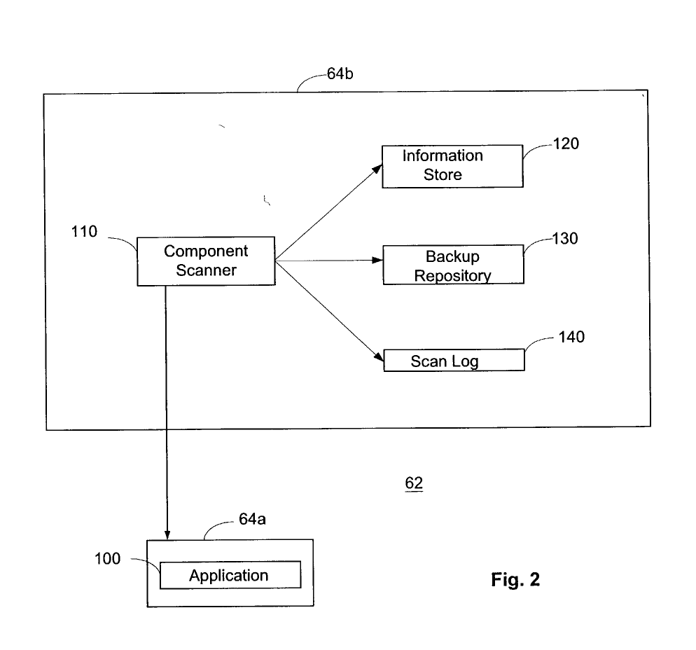

A second example of the present invention is illustrated in FIG. 2. In this example, a stand-alone computer type Computing Environment 62 is configured with the Component Scanner 110, the Information Store 120, the Backup Repository 130 and the Scan Log 140b residing on Computing System 64B. These components are tightly coupled and reside on the same Computing System 64B. Application 100 may be installed on Computing System 64A.

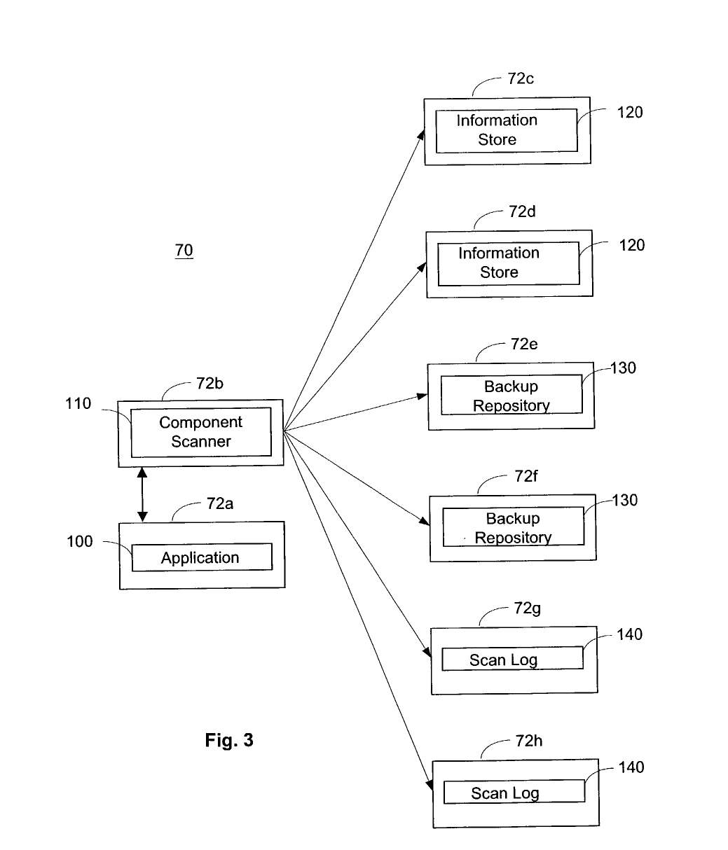

A third example of the present invention is illustrated in FIG. 3. In this example, a heterogeneous network Computing Environment 70 is configured with the Component Scanner 110 residing on Computing System 72B, and a plurality of Information Stores 120, Backup Repository 130 and Scan Log 140 residing on Computing System 72C-H. The Application may reside on Computing system 72A.

A component scanner 110 as described herein automatically detects any damaged software components damaged, lost, or corrupted component details. “Damaged” is used herein to mean a component or detail that has been modified, moved, corrupted or otherwise non-functional or not usable. “Software components and component details” includes objects, registry keys, repositories of components deployed within an object request broker. The Component Scanner 110 may also detect damaged services of the object request broker. The Component Scanner 110 may automate the recovery and restoration of damaged components, without the requirement of any human effort or intervention.

The Component Scanner 110 allows flexibility for an administrator to configure detection and recovery of the components, the services, the repository files, and the registry keys contained within the object request broker, without having to explicitly program, code or write any kind of a script for doing so. The Component Scanner 110 may provide a mechanism where by the administrator, at run time, may schedule the process of detection, without having to explicitly code or write any kind of a script to do so. The Component Scanner 110 may also provide a mechanism whereby the administrator can at run time, stop or interrupt the entire process of detection and recovery or can selectively interrupt the detection and recovery.

The Component Scanner 110 may eliminate the necessity for the developer or programmer to be aware of the techniques or methods, required to provide run time detection and recovery mechanisms of the same magnitude as that of the Component Scanner 110. The Component Scanner 110 may provide a User interface, through which the entire administration and management of the component scanner functionalities can be performed.

The Information Store 120 is a persistent storage environment or repository where the various details of the components, their published methods and other related data are stored by the Component Scanner 110. A flat file system is one example of a persistent storage environment. A database is another example. Other storage media may also be suitable. The Component Scanner 110 uses the Information Store 120 to compare the probable modifications and or additions with the original format of data.

The Backup Repository 130 is another persistent storage environment. The Component Scanner 110 stores the details of one or more selected software components in the Backup Repository 130. In the event of a situation warranting the restoration of a damaged component file deployed with the Application, 100, the Component Scanner 110 recovers the same from component details stored in the Backup Repository 130.

The Component Scanner 110 logs the results of a scan performed by the component scanner in the Scan Log 140. The Component Scanner 110 may be configured to retrieve and display the history of all scans and detections from the Scan Log 140. The Scan Log 140 may be a persistent storage environment configured to store the transactions and events of the Component Scanner 110 system. The Scan Log 140 retrieves the historical details of the events and transactions performed by the Component Scanner 110 system, when required by the Application 100.

In operation, the Component Scanner 110 checks all distributed and localized components for which it has been configured to scan and detects any changes to the published components deployed on the Application 100. The Component Scanner 110 may be configured to automatically replace any damaged component with an undamaged copy of the same stored in the Backup Repository 130.

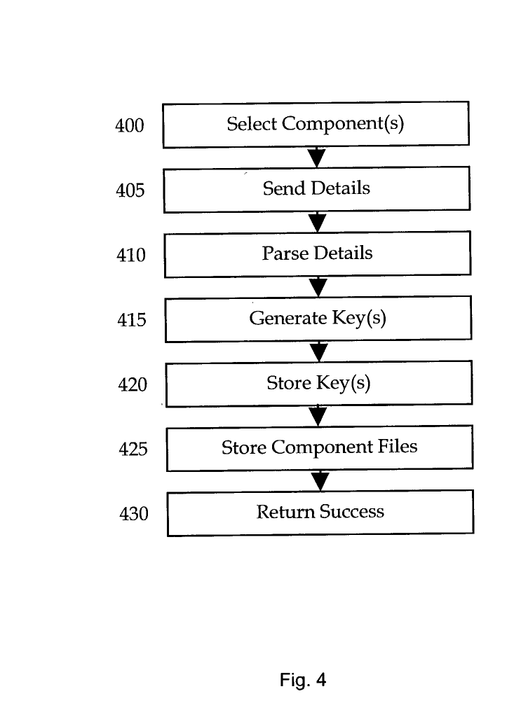

FIG. 4 illustrates one example of how a software component may be configured by a human user to be scanned by the Component Scanner 110. In this example, in step 400, the user, through an appropriate input mechanism of the Application 100, selects one or more Software Components to be scanned by Component Scanner 110. In other examples, the user may select one or more Software Components through an input mechanism of the Component Scanner 110 or the Software Components may be selected automatically.

Upon selection of a Software Component in step 405, the Application 100 transfers predetermined details corresponding to the Software Component to the Component Scanner 110. These predetermined component details may include repositories, registries, services selected by the user, a copy of the Software Component, the file locations of the Software Component or any combination of the above. On receipt of the Component Details, in step 410, the Component Scanner 110 parses the Component Details, in step 415. The Component Scanner 110 generates a Component Key to contain the component details. The Component Key contains information related to the Software Component being configured. An example of a suitable Component Key structure includes various fields, including, but not limited to, the name, the location or network path, the date and time of configuration, the last known file size (e.g., “footprint”), the number of methods or functions published or subscribed, the number of files in the component. Other component key structures may be suitable in other environments.

In step 420, the component keys are stored in the Information Store 120. In step 425, the Component Scanner 110 may store copies of files relating to the selected Software Component in the Backup Repository 130. On updating the Backup Repository 130, the Component Scanner 110 may return a success message in step 430 to the Application 100.

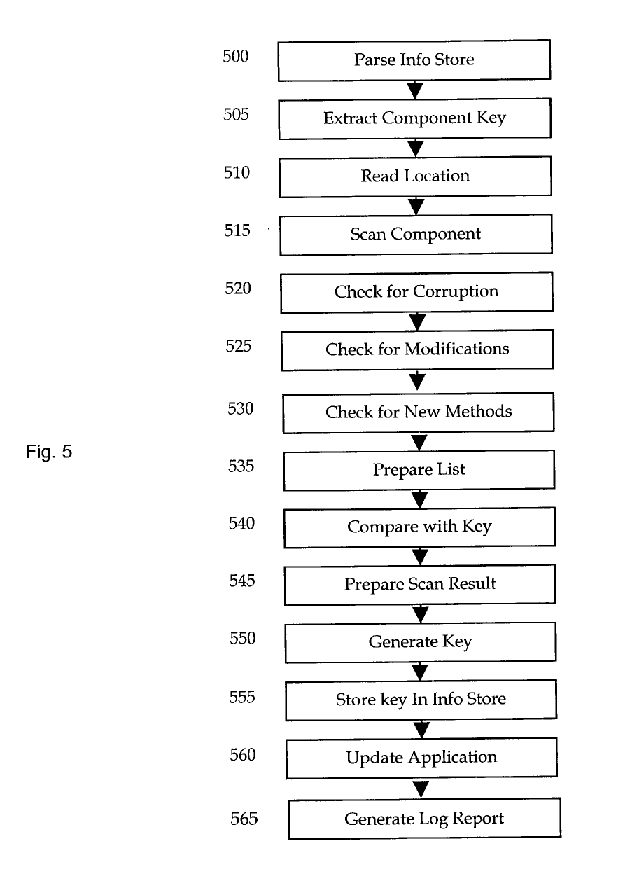

FIG. 5 illustrates an example of the sequence of Scanning of the previously selected and configured software components for damage. In step 500, the Component Scanner 110 parses the Information Store 120 in order to determine which software components have been configured and should be scanned. The Component Scanner 110 extracts the component key(s) in step 505 and in step 510 reads the location of each of the previously selected software components. Once the location of the files are determined, the Component Scanner 110 scans the Software Component in step 515. The Component Scanner 110 checks the Software Component for any corruption of its files in step 520 by comparing the file information with the original file information of the same as recorded in the Information Store 120. Such file information may include, but is not limited to, file size, last date of access, and last date of modification. The Component Scanner 110 then checks in step 525 the Software Component for any modifications to the published methods of the Software Component by, for example, extracting the method details of the component and comparing the details with those from the Information Store 120. The Component Scanner 110 may also check in step 530 the Software Component for any methods added after the component was configured for scanning. The Component Scanner 110 then prepares the list of all detections in step 535. In step 540 compares the list of detections with the component keys stored in the Information Store 120. A Key stores the information regarding the component, like the component name, the methods of the component, the signatures of such methods etc. Such a mechanism may be used to ensure a double check on the detection, because the repository from where the initial comparison is made might itself have been corrupted, whereas, the key is less susceptible to corruption as it is encrypted. The Component Scanner 110 then prepares a scan result recovery list in step 545 including the software components and translates the result into a recovery key in step 550. The recovery key is stored in the Information Store in step 555. The recovery key may contain all the information relevant to performing the recovery of the component. A separate recovery key may generated for each damaged component. In the alternative, a single key may be generated identifying all damaged components or a combination of the two may be used. Subsequently, the Component Scanner 110 updates the Application in step 560 and generates a log report in the Scan Log 140 in step 565.

The Component Scanner 110 may perform the scans to detect damaged components automatically. The scanning may be performed periodically on a predetermined schedule, or on the receipt of an indication that a component is responding in an unexpected manner to a call request. In another example, a user may initiate scanning as desired.

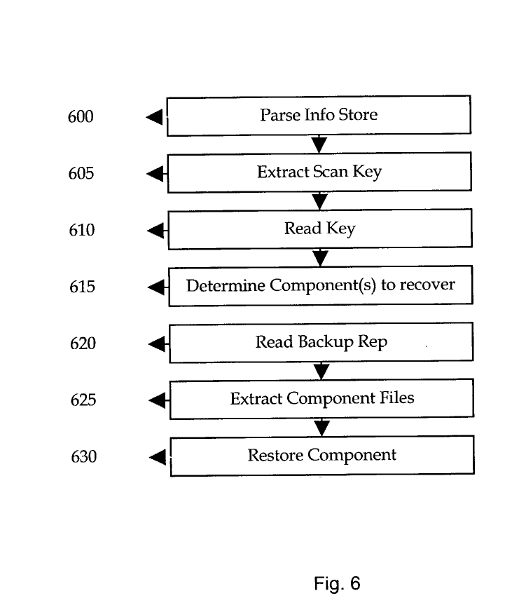

FIG. 6 illustrates an example of a sequence of recovery of a Software Component's data. In this example, the Component Scanner 110, at pre-determined intervals of time, parses the Information Store 120, extracts one or more recovery keys in step 605 and reads the keys in step 610, extracting the recovery list. Once the recovery list is extracted, the components and the data to be recovered are determined 615 by the Component Scanner 110. In step 620, the Component Scanner 110 reads the Backup Repository 130 and in step 625 extracts the appropriate component files. The Component Scanner 110 then restores the damaged component files in step 630, by copying the appropriate files of the component from the Backup Repository 130 to the original location of the component.

In other examples, on generation of a recovery list and storage of the recovery list with the Information Store 130 and logging of the same with the Scan Log 140, the Component Scanner 110 is immediately triggered to recover the files in the recovery list. The Component Scanner 110 may also extract a recovery list from the recovery key and store the recovery list in the Information Store 130, based on a request from the Application 100. The Application 100 may determine and further select one or more components to be recovered by the Component Scanner 110.

In the event the Component Scanner 110 is unable to recover a component and/or its data, the failure to recover may be communicated to the Scan Log 140. The Scan Log 140 generates an appropriate log entry, and the recovery of the component and/or its data may be re-initiated once the system is up and running. While performing the recovery of files of a component, from the Backup Repository 130 to the Component Directory, if the Destination Directory of the component is not found, Component Scanner 110 reports the same to the Scan Log 140 and tries to create a directory to store the same, if the relevant privileges are not given to create the directory, the Component Scanner stores such files in a temporary folder. The same can be recovered automatically or, in an alternate embodiment, by manual intervention. The Component Scanner 10 may be configured to make repeated attempts to recover such files, and once the directory is found the recovery will be completed. Alternatively, if the user has removed the directory, and the same or a different directory has been created, the Component Scanner 110 can be manually configured to recover the same to the new directory.

In an alternate embodiment, the Component Scanner 110 provides the user the flexibility of configuring the modes of recovery. The user can configure the Component Scanner 110 to automatically recover predetermined types of detections or data, and manually recover other types of detections or data. For example, if a component file is missing, the user can configure the Component Scanner 110 to automatically recover the component file without necessitating any request/response from the user/application. Alternatively, if a detection is made that a method of a component has changed, then the user may configure the Component Scanner 110 to inform the user of the change and wait for the user's response to recover the same.

In this way, the Component Scanner 100 can dynamically and at runtime automatically detect, recover and restore back to its original state, a damaged Software Component, including the Software Component's files, Registry Keys and Repository information, without the necessity for any human intervention or action. The Component Scanner 110 may also at run time detect, recover and restore, automatically, without any human effort or intervention, the damaged, corrupt or lost services of an Object Request Broker, or middleware that couples itself with this tool.

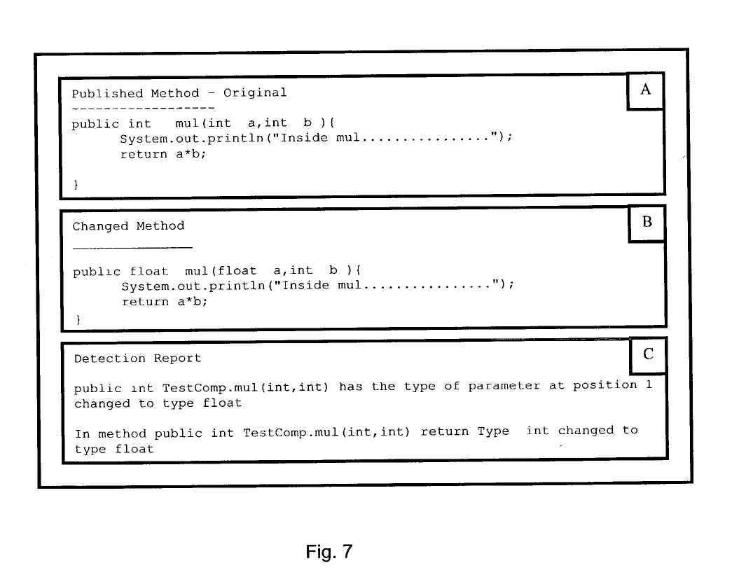

In another example, the Component Scanner 110 includes a report generation tool, which generates appropriate reports for both detections and recoveries. The reporting tool provides customizable templates through which the various in-built reports can be customized. The reports may be generated based on a pre-defined set of templates. FIG. 7 illustrates one such sample detection report generated by a reporting tool. As illustrated in the FIG. 7, Table A depicts a sample code of a component. Certain parameters of this component's method are changed as depicted in Table B, and the Application controlling the said component has not been updated of the changes. On being scanned by Component Scanner 110, the Component Scanner 110 detects the changes, and prepares a detailed report of the changes encountered Table C. This gives the application and its user a better insight into the exact nature of the changes at runtime.

What is claimed is:

1. A method of maintaining software components, comprising:
a. configuring a component scanner by:
1. selecting at least one software component;
2. extracting predetermined details of the selected software component;
3. storing the extracted predetermined details; and
4. creating a backup repository for the selected component; and
b. detecting damage to the selected software component by:
1. determining the software components for detection by parsing the stored predetermined details;
2. extracting the stored predetermined details;
3. detecting discrepancies between the details of the selected software component and the extracted, stored predetermined details; and
4. storing the results of the step of detecting discrepancies in a scan log.

2. The method of claim 1, wherein the predetermined details comprise a path corresponding to the selected component and a list of files corresponding to the selected component.

3. The method of claim 1, wherein the predetermined details comprise a copy of the selected component.

4. The method of claim 1, wherein the predetermined details comprise a repositories, registries, and services corresponding to the selected component.

5. The method of claim 1, wherein the step of extracting the predetermined details further comprises the step of a software application providing predetermined details to the component scanner, and the step of storing the extracted predetermined details comprises the component scanner generating a detail key.

6. The method of claim 5, wherein the step of determining the software components for detection by parsing the stored predetermined details further comprises extracting the component key.

7. The method of claim 1, wherein the step of extracting predetermined details further comprises extracting an original file footprint, and wherein the step of detecting discrepancies further comprises comparing a current file footprint of the selected software component with the original file footprint.

8. The method of claim 1, wherein the step of extracting predetermined details further comprises extracting method details of the selected software component, and wherein the step of detecting discrepancies further comprises comparing current method details of the selected software component with the previously extracted method details.

9. The method of claim 1, wherein the step of detecting discrepancies further comprises the step of detecting any methods added to the software component after the step of extracting predetermined details of the software component.

10. The method of claim 1, wherein the step of extracting predetermined details includes extracting a location of the software component, and the step of detecting discrepancies further comprises comparing a current location of the component with the previously extracted location of the component.

11. The method of claim 1, wherein the step of detecting discrepancies further comprises the step of:
a. reading the path of the component;
b. determining the list of files of the software component to scan;
c. reading and preparing the properties of the files in the list; and
d. comparing the properties of the files with the predetermined component details.

12. The method of claim 1, further comprising:
a. restoring a software component by:
1. determining from the scan log a software component to be recovered;
2. restoring the software component to the state at which the predetermined details were extracted.

13. The method of claim 12, wherein the step of storing the results of the step of detecting discrepancies in a scan log further comprises generating a recovery list, and the step of determining from the scan log a component to be restored further comprises extracting the recovery list.

14. The method of claim 12, wherein the step of restoring the software component further comprises:
a. determining the files of the components to recover from information in the scan log;
b. extracting at least one files associated with the software component from the backup repository;
c. determining a destination for the extracted file; and
d. transferring the extracted file to the destination.

15. The method of claim 1, further comprising;
a. reading the Scan log,
b. generating a key containing the software component and details to be recovered, and
c. inserting the key into an information store.

16. The method of claim 15, further comprising creating a temporary folder for the component files on the occurrence of an error during recovery.

17. A computer environment configured to maintain at least one software component, comprising:
a. a component scanner, configured to extract predetermined details from a selected software component;
b. an information store, responsive to the component scanner and configured to store the predetermined details;
c. a backup repository responsive to the component scanner and configured to store a copy of the selected component; and
d. a scan log, responsive to the component scanner, and configured to store detected discrepancies;
wherein the component scanner is further configured to detect damage to the selected software component by comparing the selected software component with the extracted predetermined details.

18. The computer environment of claim 17, further comprising a plurality of interconnected computer systems; wherein the component scanner, the information store, the backup repository, and the scan log reside on distinct computer systems.

19. The computer environment of claim 17, further comprising a computer system; wherein the component scanner, the information store, the backup repository, and the scan log reside on the same computer system.

20. The computer environment of claim 17, wherein the predetermined details comprise a copy of the selected component.

21. The computer environment of claim 17, wherein the predetermined details comprise a repositories, registries, and services corresponding to the selected component.

22. The computer environment of claim 17, wherein the computer environment is further configured to include at least one application, the component scanner being responsive to the application.

23. The computer environment of claim 17, wherein the information store is further configured to store a component key corresponding to the selected component.
